(19) United States
(12) Patent Application Publication
(10) Pub. No.: US 2002/0097322 A1
(43) Pub. Date: Jul. 25, 2002

(54) Multiple video display configurations and remote control of multiple video signals transmitted to a monitoring station over a network

(76) Inventors: David A. Monroe, San Antonio, TX (US); John Baird, San Anotonio, TX (US)

Correspondence Address: Attn: Robert C. Curfiss, BRACEWELL & PATTERSON, L.L.P., Suite 2900, 711 Louisiana, Houston, TX, 77027-9095, US

(21) Appl. No.: 09/725,368

(22) Filed: Nov. 29, 2000

(51) Int. Cl. H04N 7/18

(52) U.S. Cl. 348/159; 375/240.02

(57) ABSTRACT

A system for capturing, encoding and transmitting continuous video from a camera to a display monitor via a network includes a user friendly interface wherein a map is provided at a display screen for illustrating the location of the cameras and indicating the direction of the camera angle. The monitor includes a display area for selectively displaying selected cameras and for controlling the selection, display and direction of the cameras from a remote location. The display screen can be configured to display one or any combination of cameras. The cameras can be selected by manual selection, pre-programmed sequencing or by event detection with the selected camera automatically displayed on the display area. Secondary monitors may be incorporated to enhance the display features. The secondary monitors are controlled by the control panel provided on the primary monitor.

### BACKGROUND OF THE INVENTION

1. Field of the Invention

The invention is generally related to digital video transmission systems and is specifically directed to a method and apparatus for displaying, mapping and controlling video streams distributed over a network for supporting the transmission of live, near real-time video data in a manner to maximize display options through remote control from a monitoring station.

2. Discussion of the Prior Art

Prior art video security systems typically use a plurality of analog cameras, which generate composite-video signals, often in monochrome. The analog video signals are delivered to a centralized monitoring station and displayed on a suitable monitor.

Such systems often involve more than one video camera to monitor the premises. It is thus necessary to provide a means to display these multiple video signals. Three methods are in common use:

Some installations simply use several video monitors at the monitoring station, one for each camera in the system. This places a practical limit on the number of cameras that the system can have.

A time-sequential video switcher may be used to route multiple cameras to one monitor, one at a time. Such systems typically ‘dwell’ on each camera for several seconds before switching to the next camera. This method obviously leaves each camera unseen for the majority of the time.

Newer systems accept several simultaneous video input signals and display them all simultaneously on a single display monitor. The individual video signals are arranged in a square grid, with 1, 4, 9, or 16 cameras simultaneously shown on the display.

A typical prior art system is the Multivision Pro MV-96p, manufactured by Sensormatic Video Products Division. This device accepts sixteen analog video inputs, and uses a single display monitor to display one, four, nine, or sixteen of the incoming video signals. The device digitizes all incoming video signals, and decimates them as necessary to place more than one video on the display screen. The device is capable of detecting motion in defined areas of each camera's field of view. When motion is detected, the device may, by prior user configuration, turn on a VCR to record specific video inputs, and may generate an alarm to notify security personnel.

While typical of prior art systems, the device is not without deficiencies. First, video may be displayed only on a local, attached monitor and is not available to a wider audience via a network. Second, individual videos are recorded at a lower frame rate than the usual 30 frames/second. Third, video is recorded on an ordinary VHS-format cassette tape, which makes searching for a random captured event tedious and time-consuming. Finally, the system lacks the familiar and commonplace User Interface typically available on a computer-based product.

With the availability of cameras employing digital encoders that produce industry-standard digital video streams such as, by way of example, MPEG-1 streams, it is possible to transmit a plurality of digitized video streams. It would be, therefore, desirable to display any combination of the streams on one or more video screens. The use of MPEG-1 streams is advantageous due to the low cost of the encoder hardware, and to the ubiquity of software MPEG-1 players. However, difficulties arise from the fact that the MPEG-1 format was designed primarily to support playback of recorded video from a video CD, rather than to support streaming of ‘live’ sources such as surveillance cameras and the like.MPEG system streams contain multiplexed elementary bit streams containing compressed video and audio. Since the retrieval of video and audio data from the storage medium (or network) tends to be temporally discontinuous, it is necessary to embed certain timing information in the respective video and audio elementary streams. In the MPEG-1 standard, these consist of Presentation Timestamps (PTS) and, optionally, Decoding Timestamps (DTS).

On desktop computers, it is common practice to play MPEG-1 video and audio using a commercially available software package, such as, by way of example, the Microsoft Windows Media Player. This software program may be run as a standalone application. Otherwise, components of the player may be embedded within other software applications.

Media Player, like MPEG-1 itself, is inherently file-oriented and does not support playback of continuous sources such as cameras via a network. Before Media Player begins to play back a received video file, it must first be informed of certain parameters including file name and file length. This is incompatible with the concept of a continuous streaming source, which may not have a filename and which has no definable file length.

Moreover, the time stamping mechanism used by Media Player is fundamentally incompatible with the time stamping scheme standardized by the MPEG-1 standard. MPEG-1 calls out a time stamping mechanism which is based on a continuously incrementing 94 kHz clock located within the encoder. Further, the MPEG-1 standard assumes no Beginning-of-File marker, since it is intended to produce a continuous stream.

Media Player, on the other hand, accomplishes time stamping by counting 100's of nanoseconds since the beginning of the current file.

### SUMMARY OF THE INVENTION

The subject invention is directed to an IP-network-based surveillance and monitoring system wherein video captured from a number of remotely located security cameras may be digitized, compressed, and networked for access, review and control at a remote monitoring station. The preferred embodiment incorporates a streaming video system for capturing, encoding and transmitting continuous video from a camera to a display monitor via a network includes an encoder for receiving a video signal from the camera, the encoder producing a high-resolution output signal and a low-resolution output signal representing the video signal, a router or switch for receiving both the high-resolution output signal and the low-resolution output signal and a display monitor in communication with the router for selectively displaying either the high-resolution output signal or the low-resolution output signal. It will be understood by those skilled in the art that the terms “router and/or switch” as used herein is intended as a generic term for receiving and rerouting a plurality of signals. Hubs, switched hubs and intelligent routers are all included in the terms “router and/or switch” as used herein.

In the preferred embodiment the camera videos are digitized and encoded in three separate formats: motion MPEG-1 at 352×240 resolution, motion MPEG-1 at 176×112 resolution, and JPEG at 720×480 resolution. Each remote monitoring station is PC-based with a plurality of monitors, one of which is designated a primary monitor. The primary monitor provides the user interface function screen and the other, secondary monitors are adapted for displaying full screen, split screen and multiple screen displays of the various cameras. Each video stream thus displayed requires the processor to run an instance of the video player, such as by way of example, Microsoft Media Player. A single Pentium III 500 MHz processor can support a maximum of 16 such instance, provided that the input video is constrained to QSIF resolution and a bitrate of 128 kb/s.

The novel user interface functions of the system interact with the system through the browser. Initially, a splash screen occurs, containing the login dialog. A check box is provided to enable an automatic load of the user's last application settings. After logon, the server loads a series of HTML pages which, with the associated scripts and applets, provide the entire user interface. Users equipped with a single-monitor system interact with the system entirely through the primary screen. Users may have multiple secondary screens, which are controlled by the primary screen. In the preferred embodiment the primary screen is divided into three windows: the map window; the video window and the control window.

The primary screen map window contains a map of the facility and typically is a user-supplied series of one or more bitmaps. Each map contains icons representing cameras or other sensor sites. Each camera/sensor icon represents the position of the camera within the facility. Each site icon represents another facility or function site within the facility. In addition, camera icons are styled so as to indicate the direction the camera is pointed. When a mouse pointer dwells over a camera icon for a brief, predefined interval, a “bubble” appears identifying the camera. Each camera has an associated camera ID or camera name. Both of these are unique alphanumeric names of 20 characters or les and are maintained in a table managed by the server. The camera ID is used internally by the system to identify the camera and is not normally seen by the user. The camera name is a user-friendly name, assigned by the user and easily changeable from the user screen. Any user with administrator privileges may change the camera name.

In the preferred embodiment, the map window is a pre-defined size, typically 510 pixels by 510 pixels. The bit map may be scaled to fit with the camera icons accordingly repositioned.

When the mouse pointer dwells over a camera icon for a brief time, a bubble appears which contains the camera name. If the icon is double left clicked, then that camera's video appears on the primary screen video window in a full screen view. If the icon is right clicked, a menu box appears with further options such as: zone set up; camera set up; and event set up.

When the mouse pointer dwells on a site or sensor icon for a brief time a bubble appears with the site or sensor name. When the icon is double left clicked, the linked site is loaded into the primary screen with the previous site retained as a pull down. Finally, the user may drag and drop a camera icon into any unused pane in the primary screen video window. The drag and drop operation causes the selected camera video to appear in the selected pane. The position of the map icon is not affected by the drag and drop operation.

In the preferred embodiment two pull down lists are located beneath the map pane. A “site” list contains presets and also keeps track of all of the site maps visited during the current session and can act as a navigation list. A “map” list allows the user to choose from a list of maps associated with the site selected in the site list.

The control window is divided into multiple sections, including at least the following: a control section including logon, site, presets buttons and a real-time clock display; a control screen section for reviewing the image database in either a browse or preset mode; and a live view mode. In the live and browse modes events can be monitored and identified by various sensors, zones may be browsed, specific cameras may be selected and various other features may be monitored and controlled.

The primary screen video window is used to display selected cameras from the point-click-and drag feature, the preset system, or the browse feature. This screen and its functions also control the- secondary monitor screens. The window is selectively a full window, split-window or multiple pane windows and likewise can display one, two or multiple cameras simultaneously. The user-friendly camera name is displayed along with the camera video. The system is set up so that left clicking on the pane will “freeze-frame” the video in a particular pane. Right clicking on the pane will initiate various functions. Each video pane includes a drag and drop feature permitting the video in a pane to moved to any other pane, as desired.

In those monitoring stations having multiple displays, the primary display screen described above is also used to control the secondary screens. The secondary screens are generally used for viewing selected cameras and are configured by code executing on the primary screen. The video pane(s) occupy the entire active video area of the secondary screens.

The system supports a plurality of cameras and an encoder associated with each of the cameras, the high-resolution output signal and low-resolution output signal unique to each camera being transmitted to the router. A management system is associated with each display monitor whereby each of the plurality of display monitors is adapted for displaying any combination of camera signals independently of the other of said plurality of display monitors.

The system of includes a selector for selecting between the high-resolution output signal and the low-resolution output signal based on the dimensional size of the display. The selector may be adapted for manually selecting between the high-resolution output signal and the low-resolution output signal. Alternatively, a control device may be employed for automatically selecting between the high-resolution output signal and the low-resolution output signal based on the size of the display. In one aspect of the invention, the control device may be adapted to assign a priority to an event captured at a camera and selecting between the high-resolution output signal and the low-resolution output signal based on the priority of the event.

It is contemplated that the system will be used with a plurality of cameras and an encoder associated with each of said cameras. The high-resolution output signal and low-resolution output signal unique to each camera is then transmitted to a router or switch, wherein the display monitor is adapted for displaying any combination of camera signals. In such an application, each displayed signal at a display monitor is selected between the high-resolution signal and the low-resolution signal of each camera dependent upon the number of cameras signals simultaneously displayed at the display monitor or upon the control criteria mentioned above.

The video system of the subject invention is adapted for supporting the use of a local-area-network (LAN) or wide-area-network (WAN), or a combination thereof, for distributing digitized camera video on a real-time or “near” real-time basis.

In the preferred embodiment of the invention, the system uses a plurality of video cameras, disposed around a facility to view scenes of interest. Each camera captures the desired scene, digitizes (and encodes) the resulting video signal, compresses the digitized video signal, and sends the resulting compressed digital video stream to a multicast address. One or more display stations may thereupon view the captured video via the intervening network.

Streaming video produced by the various encoders is transported over a generic IP network to one or more users. User workstations contain one or more ordinary PC's, each with an associated video monitor. The user interface is provided by an HTML application within an industry-standard browser, for example Microsoft Internet Explorer.

The subject invention comprises an intuitive and user-friendly method for selecting cameras to view. The main user interface screen provides the user with a map of the facility, which is overlaid with camera-shaped icons depicting location and direction of the various cameras and encoders. This main user interface has, additionally, a section of the screen dedicated to displaying video from the selected cameras.

The video display area of the main user interface may be arranged to display a single video image, or may be subdivided by the user into arrays of 4, 9, or 16 smaller video display areas.

Selection of cameras, and arrangement of the display area, is controlled by a mouse and conventional Windows user-interface conventions. Users may:

Select the number of video images to be displayed within the video display area. This is done by pointing and clicking on icons representing screens with the desired number of images.

Display a desired camera within a desired ‘pane’ in the video display area. This is done by pointing to the desired area on the map, then ‘dragging’ the camera icon to the desired pane.

Edit various operating parameters of the encoders. This is done by pointing to the desired camera, the right-clicking the mouse. The user interface then drops a dynamically generated menu list, which allows the user to adjust the desired encoder parameters.

One aspect of the invention is the intuitive and user-friendly method for selecting cameras to view. The breadth of capability of this feature is shown in FIG. 3. The main user interface screen provides the user with a map of the facility, which is overlaid with camera-shaped icons depicting location and direction of the various cameras and encoders. This main user interface has, additionally, a section of the screen dedicated to displaying video from the selected cameras.

The system may employ single or multiple video screen monitor stations. Single-monitor stations, and the main or primary monitor in multiple-monitor stations, present a different screen layout than secondary monitors in a multiple-monitor system. The main control monitor screen is divided into three functional areas: a map pane, a video display pane, and a control pane. The map pane displays one or more maps. Within the map pane, a specific site may be selected via mouse-click in a drop-down menu. Within the map pane, one or more maps relating to the selected site may be selected via mouse-click on a drop-down menu of maps. The sensors may be video cameras and may also include other sensors such as motion, heat, fire, acoustic sensors and the like. All user screens are implemented as HTML or XML pages generated by a network application server. The operating parameters of the camera including still-frame capture versus motion capture, bit-rate of the captured and compressed motion video, camera name, camera caption, camera icon direction in degrees, network address of the various camera encoders, and quality of the captured still-frame or motion video.

Monitoring stations which employ multiple display monitors use the user interface screen to control secondary monitor screens. The secondary monitor screens differ from the primary monitor screen in that they do not posses map panes or control panes but are used solely for the purpose of displaying one or more video streams from the cameras. In the preferred embodiment the secondary monitors are not equipped with computer keyboards or mice. The screen layout and contents of video panes on said secondary monitors is controlled entirely by the User Interface of the Primary Monitor.

The primary monitor display pane contains a control panel comprising a series of graphical buttons which allow the user to select which monitor he is currently controlling. When controlling a secondary monitor, the video display region of the primary monitor represents and displays the screen layout and display pane contents of the selected secondary monitor. It is often the case that the user may wish to observe more than 16 cameras, as heretofore discussed. To support this, the system allows the use of additional PC's and monitors. The additional PC's and monitors operate under the control of the main user application. These secondary screens do not have the facility map, as does the main user interface. Instead, these secondary screens use the entire screen area to display selected camera video.These secondary screens would ordinarily be controlled with their own keyboard and mouse interface systems. Since it is undesirable to clutter the user's workspace with multiple input interface systems, these secondary PC's and monitors operate entirely under the control of the main user interface. To support this, a series of button icons are displayed on the main user interface, labeled, for example, PRIMARY, 2,3, and 4. The video display area of the primary monitor then displays the video that will be displayed on the selected monitor. The primary PC, then, may control the displays on the secondary monitors. For example, a user may click on the ‘2’ button, which then causes the primary PC to control monitor number two. When this is done, the primary PC's video display area also represents what will be displayed on monitor number two. The user may then select any desired camera from the map, and drag it to a selected pane in the video display area. When this is done, the selected camera video will appear in the selected pane on screen number 2.Streaming video signals tend to be bandwidth-intensive. Furthermore, since each monitor is capable of displaying up to 16 separate video images, the bandwidth requirements of the system can potentially be enormous. It is thus desirable to minimize the bandwidth requirements of the system.To address this, each encoder is equipped with at least two MPEG-1 encoders. When the encoder is initialized, these two encoders are programmed to encode the same camera source into two distinct streams: one low-resolution low-bit rate stream, and one higher-resolution, higher-bit rate stream.When the user has configured the video display area to display a single image, that image is obtained from the desired encoder using the higher-resolution, higher-bit rate stream. The same is true when the user subdivides the video display area into a 2×2 array; the selected images are obtained from the high-resolution, high-bit rate streams from the selected encoders. The network bandwidth requirements for the 2×2 display array are four times the bandwidth requirements for the single image, but this is still an acceptably small usage of the network bandwidth.However, when the user subdivides a video display area into a 3×3 array, the demand on network bandwidth is 9 times higher than in the single-display example. And when the user subdivides the video display area into a 4×4 array, the network bandwidth requirement is 16 times that of a single display. To prevent network congestion, video images in a 3×3 or 4×4 array are obtained from the low-resolution, low-speed stream of the desired encoder. Ultimately, no image resolution is lost in these cases, since the actual displayed video size decreases as the screen if subdivided. That is, if a higher-resolution image were sent by the encoder, the image would be decimated anyway in order to fit it within the available screen area.It is, therefore, an object and feature of the subject invention to provide the means and method for displaying “live” streaming video over a commercially available media player system.It is a further object and feature of the subject invention to provide the means and method for permitting multiple users to access and view the live streaming video at different time, while in process without interrupting the transmission.

It is a further object and feature of the subject invention to permit conservation of bandwidth by incorporating a multiple resolution scheme permitting resolution to be selected dependent upon image size and use of still versus streaming images.

It is an additional object and feature of the subject invention to provide a user-friendly screen interface permitting a user to select, control and operate the system from a single screen display system.

It is a further object and feature of the subject invention to permit selective viewing of a mapped zone from a remote station.

It is another object and feature of the subject invention to provide for camera selection and aiming from a remote station.

Other objects and feature of the subject invention will be readily apparent from the accompanying drawings and detailed description of the preferred embodiment.

### BRIEF DESCRIPTION OF THE DRAWINGS

FIG. 1 is a block diagram of a typical multi-camera system in accordance with the subject invention.

FIG. 2 is an illustration of the scheme for multicast address resolution.

FIG. 3 illustrates a typical screen layout.

FIG. 4 is an illustration of the use of the bandwidth conservation scheme of the subject invention.

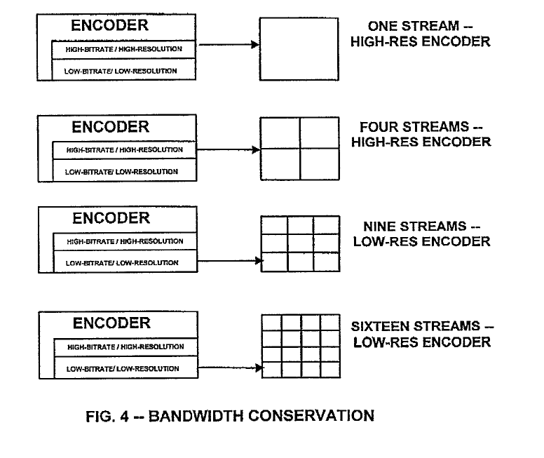

FIG. 5 is an illustration of the user interface for remote control of camera direction.

FIG. 6 is an illustration of the user interface for highlighting, activating and displaying a camera signal.

FIG. 7 is an illustration of the multiple screen layout and setup.

FIG. 8 is an illustration of the dynamic control of screens and displays of various cameras using the user interface scheme of the subject invention.

### DETAILED DESCRIPTION OF THE PREFERRED EMBODIMENT

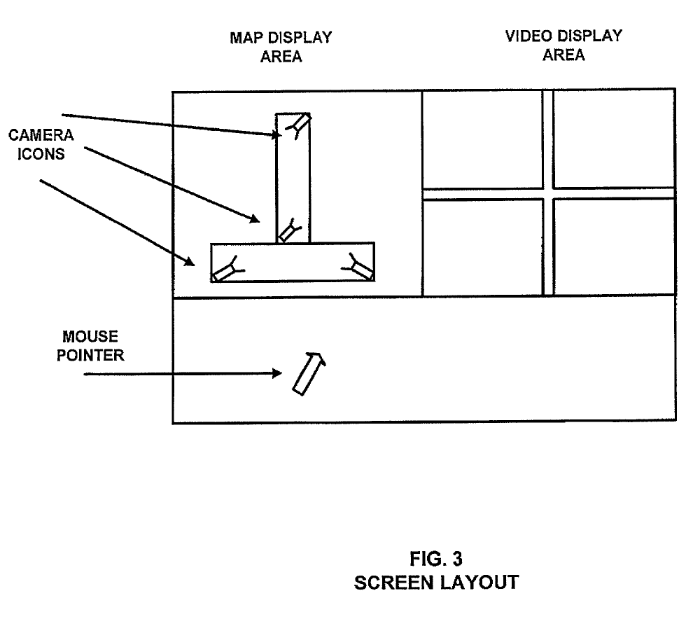

One aspect of the invention is the intuitive and user-friendly method for selecting cameras to view. The breadth of capability of this feature is shown in FIG. 3. The main user interface screen provides the user with a map of the facility, which is overlaid with camera-shaped icons depicting location and direction of the various cameras and encoders. This main user interface has, additionally, a section of the screen dedicated to displaying video from the selected cameras.

The video display area of the main user interface may be arranged to display a single video image, or may be subdivided by the user into arrays of 4, 9, or 16 smaller video display areas. Selection of cameras, and arrangement of the display area, is controlled by the user using a mouse and conventional Windows user-interface conventions. Users may:

Select the number of video images to be displayed within the video display area. This is done by pointing and clicking on icons representing screens with the desired number of images.

Display a desired camera within a desired ‘pane’ in the video display area. This is done by pointing to the desired area on the map, then ‘dragging’ the camera icon to the desired pane.

Edit various operating parameters of the encoders. This is done by pointing to the desired camera, the right-clicking the mouse. The user interface then drops a dynamically generated menu list that allows the user to adjust the desired encoder parameters.

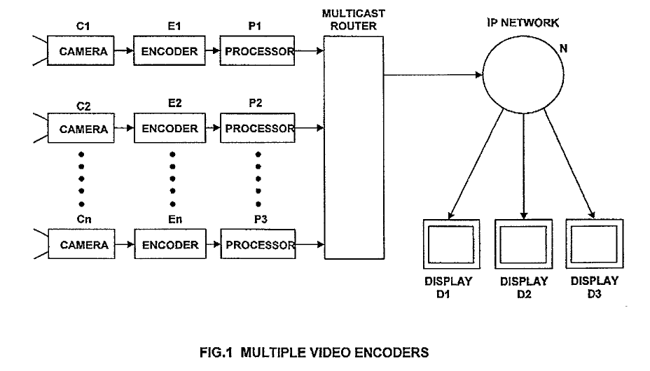

The video surveillance system of the subject invention is specifically adapted for distributing digitized camera video on a real-time or near real-time basis over a LAN and/or a WAN. As shown in FIG. 1, the system uses a plurality of video cameras C1, C2 . . . Cn, disposed around a facility to view scenes of interest. Each camera captures the desired scene, digitizes the resulting video signal at a dedicated encoder module E1, E2 . . . En, respectively, compresses the digitized video signal at the respective compressor P1, P2 . . . Pn, and sends the resulting compressed digital video stream to a multicast address router R. One or more display stations D1, D2 . . . Dn may thereupon view the captured video via the intervening network N. The network may be hardwired or wireless, or a combination, and may either a Local Area Network (LAN) or a Wide Area Network (WAN), or both.

The preferred digital encoders E1, E2 . . . En produce industry-standard MPEG-1 digital video streams. The use of MPEG-1 streams is advantageous due to the low cost of the encoder hardware, and to the ubiquity of software MPEG-1 players.

On desktop computers, it is common practice to play MPEG-1 video and audio using a proprietary software package such as, by way of example, the Microsoft Windows Media Player. This software program may be run as a standalone application, otherwise components of the player may be embedded within other software applications.

Any given source of encoded video may be viewed by more than one client. This could hypothetically be accomplished by sending each recipient a unique copy of the video stream. However, this approach is tremendously wasteful of network bandwidth.

A superior approach is to transmit one copy of the stream to multiple recipients, via Multicast Routing. This approach is commonly used on the Internet, and is the subject of various Internet Standards (RFC's). In essence, a video source sends its' video stream to a Multicast Group Address, which exists as a port on a Multicast-Enabled network router or switch. The router or switch then forwards the stream only to IP addresses, which have known recipients. Furthermore, if the router or switch can determine that multiple recipients are located on one specific network path or path segment, the router or switch sends only one copy of the stream to that path.

From a client's point of view, the client need only connect to a particular Multicast Group Address to receive the stream. A range of IP addresses has been reserved for this purpose; essentially all IP addresses from 224.0.0.0 to 239.255.255.255 have been defined as Multicast Group Addresses.

Unfortunately, there is not currently a standardized mechanism to dynamically assign these Multicast Group Addresses, in a way that is known to be globally unique.

This differs from the ordinary Class A, B, or C IP address classes. In these classes, a regulatory agency assigns groups of IP addresses to organizations upon request, and guarantees that these addresses are globally unique. Once assigned this group of IP addresses, a network administrator may allocate these addresses to individual hosts, either statically or dynamically DHCP or equivalent network protocols. This is not true of Multicast Group Addresses; they are not assigned by any centralized body and their usage is therefore not guaranteed to be globally unique.

Each encoder must possess two unique IP addresses—the unique Multicast Address used by the encoder to transmit the video stream, and the ordinary Class A, B, or C address used for more mundane purposes. It is thus necessary to provide a means to associate the two addresses, for any given encoder.

The subject invention includes a mechanism for associating the two addresses.

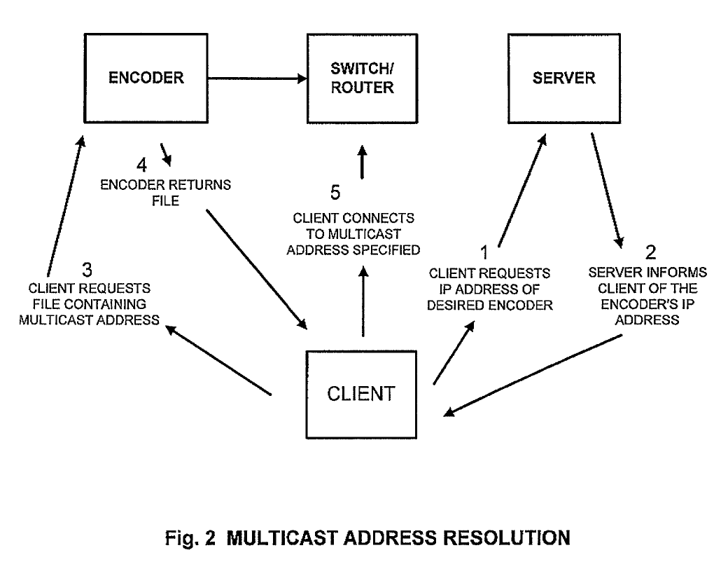

This method establishes a sequential transaction between the requesting client and the desired encoder. An illustration of this technique is shown in FIG. 2.

First, the client requesting the video stream identifies the IP address of the desired encoder. This is normally done via graphical methods, described more fully below. Once the encoder's IP address is known, the client obtains a small file from an associated server, using FTP, TFTP or other appropriate file transfer protocol over TCP/IP. The file, as received by the requesting client, contains various operating parameters of the encoder including frame rate, UDP bit rate, image size, and most importantly, the Multicast Group Address associated with the encoder's IP address. The client then launches an instance of Media Player, initializes the previously described front end filter, and directs Media Player to receive the desired video stream from the defined Multicast Group Address.

Streaming video produced by the various encoders is transported over a generic IP network to one or more users. User workstations contain one or more ordinary PC's, each with an associated video monitor. The user interface is provided by an HTML application within an industry-standard browser, specifically Microsoft Internet Explorer.

Some sample source is listed below:

// this function responds to a dragStart event on a camera
function cameraDragStart(i)
{

event.dataTransfer.setData(“text”,currSite.siteMaps[currSite.currMap].h
otSpots[i].camera.id);

dragSpot = currSite.siteMaps[currSite.currMap].hotSpots[i];
event.dataTransfer.dropEffect = “copy”;
dragging = true;
event.cancelBubble = true;

}
// this function responds to a dragStart event on a cell
// we might be dragging a hotSpot or a zone
function cellDragStart(i)
{

}
}

// this function responds to a drop event on a cell input element
function drop(i)
{

| | |
|---|---|
| if (dragSpot != null) | // dragging |

a hotSpot

{

}

| | |
|---|---|
| else if (dragZone != null) | // dragging |

a zone object

{

| | |
|---|---|
| currMonitor.zones[i]= dragZone; | // set the cell |

zone

| | |
|---|---|
| dragZone = null; | // |

null dragZone

| | |
|---|---|
| zoneVideo(currMonitor.id, i); | // start |

the video

}

else

{

}

else
{

| | |
|---|---|
| dropCameraId(currMonitor,d,i); | // setup hotSpot |

| | |
|---|---|
| startMonitorVideo(currMonitor, i); | // start |

the video

| | |
|---|---|
| displayCells (); | // |

redisplay the monitor cells

}

}
dragging = false;
event.cancelBubble = true;

}

In the foregoing code, the function:

event.data Transfer.setData (“text”,currSite.siteMaps[currSite. currMap].hotspots [i].camera.id)

retrieves the IP address of the encoder that the user has clicked. The subsequent function startMonitorVideo(currMonitor, i) passes the IP address of the selected encoder to an ActiveX control that then decodes and renders video from the selected source.

The system of includes a selector for selecting between the high-resolution output signal and the low-resolution output signal based on the dimensional size of the display. The selector may be adapted for manually selecting between the high-resolution output signal and the low-resolution output signal. Alternatively, a control device may be employed for automatically selecting between the high-resolution output signal and the low-resolution output signal based on the size of the display. In one aspect of the invention, the control device may be adapted to assign a priority to an event captured at a camera and selecting between the high-resolution output signal and the low-resolution output signal based on the priority of the event.

It is contemplated that the system will be used with a plurality of cameras and an encoder associated with each of said cameras. The high-resolution output signal and low-resolution output signal unique to each camera is then transmitted to a router or switch, wherein the display monitor is adapted for displaying any combination of camera signals. In such an application, each displayed signal at a display monitor is selected between the high-resolution signal and the low-resolution signal of each camera dependent upon the number of cameras signals simultaneously displayed at the display monitor or upon the control criteria mentioned above.

It is often the case that the user may wish to observe more than 16 cameras, as heretofore discussed. To support this, the system allows the use of additional PC's and monitors. The additional PC's and monitors operate under the control of the main user application. These secondary screens do not have the facility map, as does the main user interface. Instead, these secondary screens use the entire screen area to display selected camera video.

These secondary screens would ordinarily be controlled with their own keyboards and mice. Since it is undesirable to clutter the user's workspace with multiple mice, these secondary PC's and monitors operate entirely under the control of the main user interface. To support this, a series of button icons are displayed on the main user interface, labeled, for example, PRIMARY, 2,3, and 4. The video display area of the primary monitor then displays the video that will be displayed on the selected monitor. The primary PC, then, may control the displays on the secondary monitors. For example, a user may click on the ‘2’ button, which then causes the primary PC to control monitor number two. When this is done, the primary PC's video display area also represents what will be displayed on monitor number two. The user may then select any desired camera from the map, and drag it to a selected pane in the video display area. When this is done, the selected camera video will appear in the selected pane on screen number 2.

Streaming video signals tend to be bandwidth-intensive. The subject invention provides a method for maximizing the use of available bandwidth by incorporating multiple resolution transmission and display capabilities. Since each monitor is capable of displaying up to 16 separate video images, the bandwidth requirements of the system can potentially be enormous. It is thus desirable to minimize the bandwidth requirements of the system.

To address this, each encoder is equipped with at least two MPEG-1 encoders.

When the encoder is initialized, these two encoders are programmed to encode the same camera source into two distinct streams: one low-resolution low-bit rate stream, and one higher-resolution, higher-bit rate stream.

When the user has configured the video display area to display a single image, that image is obtained from the desired encoder using the higher-resolution, higher-bit rate stream. The same is true when the user subdivides the video display area into a 2×2 array; the selected images are obtained from the high-resolution, high-bit rate streams from the selected encoders. The network bandwidth requirements for the 2×2 display array are four times the bandwidth requirements for the single image, but this is still an acceptably small usage of the network bandwidth.

However, when the user subdivides a video display area into a 3×3 array, the demand on network bandwidth is 9 times higher than in the single-display example. And when the user subdivides the video display area into a 4×4 array, the network bandwidth requirement is 16× that of a single display. To prevent network congestion, video images in a 3×3 or 4×4 array are obtained from the low-resolution, low-speed stream of the desired encoder. Ultimately, no image resolution is lost in these cases, since the actual displayed video size decreases as the screen if subdivided. If a higher-resolution image were sent by the encoder, the image would be decimated anyway in order to fit it within the available screen area.

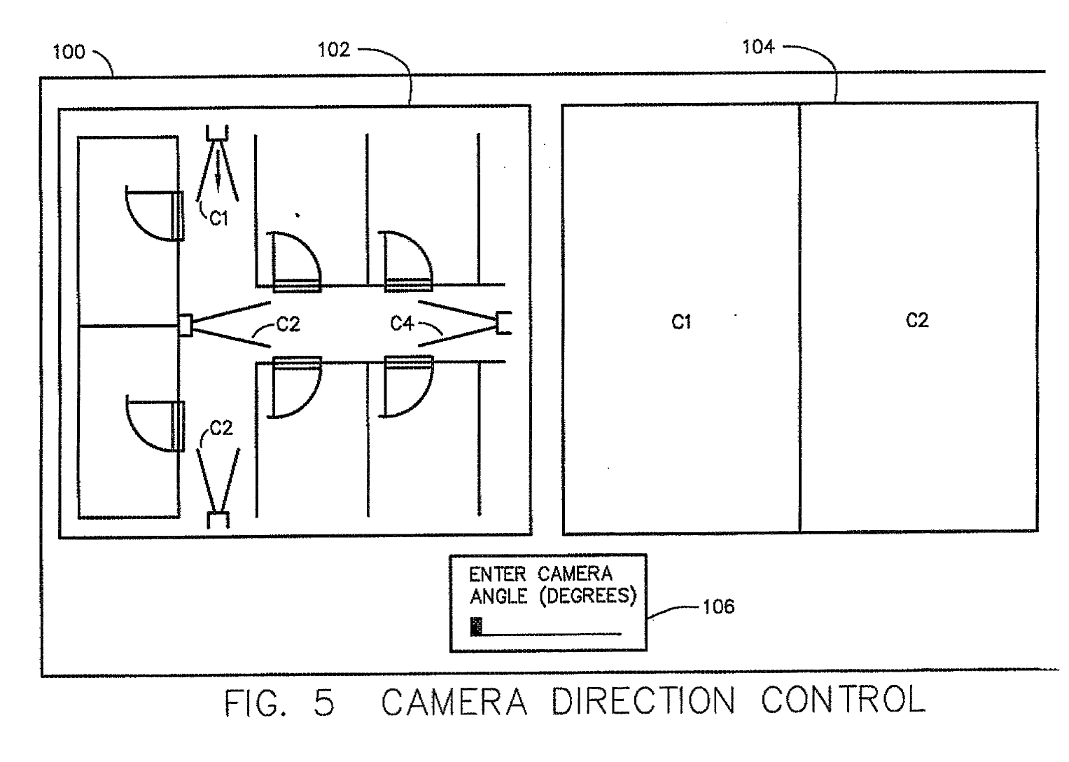

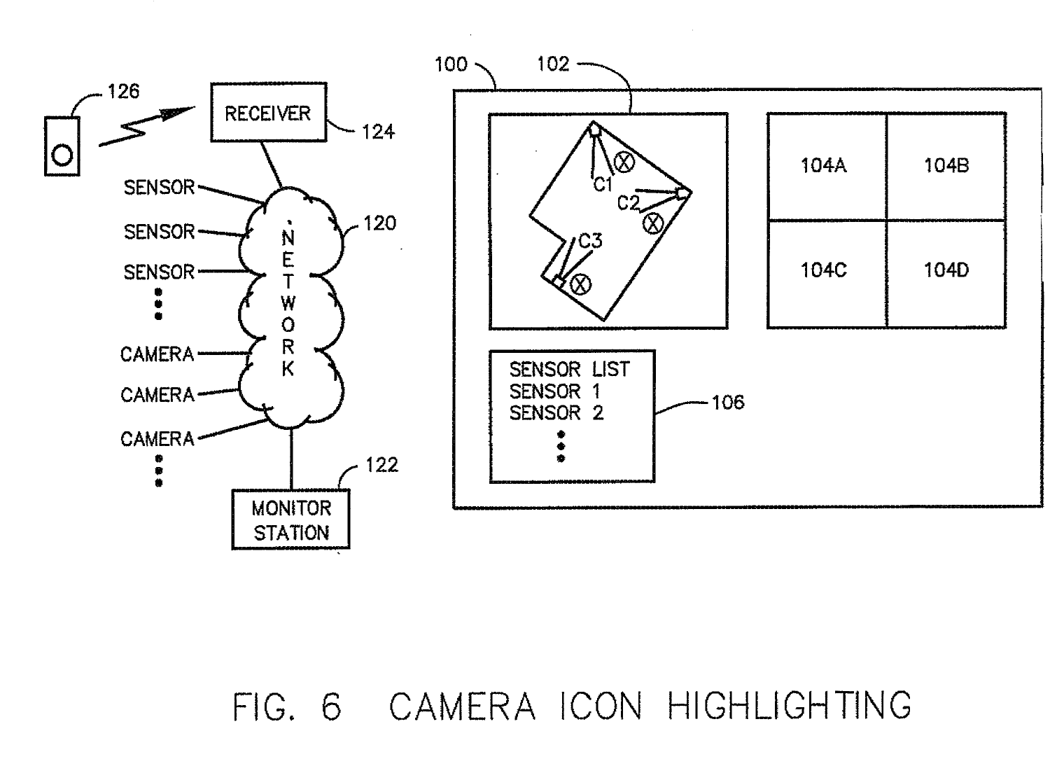

The user interface operations are shown in FIGS. 5-8. In general, interface functions of the system interact with the system through the browser. Initially, a splash screen occurs, containing the login dialog. A check box is provided to enable an automatic load of the user's last application settings. After logon, the server loads a series of HTML pages, which, with the associated scripts and applets, provide the entire user interface. Users equipped with a single-monitor system interact with the system entirely through the primary screen. Users may have multiple secondary screens, which are controlled by the primary screen. In the preferred embodiment the primary screen is divided into three windows: the map window; the video window and the control window.

The primary screen map window contains a map of the facility and typically is a user-supplied series of one or more bitmaps. Each map contains icons representing cameras or other sensor sites. Each camera/sensor icon represents the position of the camera within the facility. Each site icon represents another facility or function site within the facility. In addition, camera icons are styled so as to indicate the direction the camera is pointed. When a mouse pointer dwells over a camera icon for a brief, predefined interval, a “bubble” appears identifying the camera. Each camera has an associated camera ID or camera name. Both of these are unique alphanumeric names of 20 characters or les and are maintained in a table managed by the server. The camera ID is used internally by the system to identify the camera and is not normally seen by the user. The camera name is a user-friendly name, assigned by the user and easily changeable from the user screen. Any user with administrator privileges may change the camera name.

In the preferred embodiment, the map window is a pre-defined size, typically 510 pixels by 510 pixels. The bit map may be scaled to fit with the camera icons accordingly repositioned.

When the mouse pointer dwells over a camera icon for a brief time, a bubble appears which contains the camera name. If the icon is double left clicked, then that camera's video appears on the primary screen video window in a full screen view. If the icon is right clicked, a menu box appears with further options such as: zone set up; camera set up; and event set up.

When the mouse pointer dwells of a site or sensor icon for a brief time a bubble appears with the site or sensor name. When the icon is double left clicked, the linked site is loaded into the primary screen with the previous site retained as a pull down. Finally, the user may drag and drop a camera icon into any unused pane in the primary screen video window. The drag and drop operation causes the selected camera video to appear in the selected pane. The position of the map icon is not affected by the drag and drop operation.

In the preferred embodiment two pull down lists are located beneath the map pane. A 3∂site” list contains presets and also keeps track of all of the site maps visited during the current session and can act as a navigation list. A “map” list allows the user to choose from a list of maps associated with the site selected in the site list.

The control window is divided into multiple sections, including at least the following: a control section including logon, site, presets buttons and a real-time clock display; a control screen section for reviewing the image database in either a browse or preset mode; and a live view mode. In the live and browse modes events can be monitored and identified by various sensors, zones may be browsed, specific cameras may be selected and various other features may be monitored and controlled.

The primary screen video window is used to display selected cameras from the point-click-and drag feature, the preset system, or the browse feature. This screen and its functions also control the secondary monitor screens. The window is selectively a full window, split-window or multiple pane windows and likewise can display one, two or multiple cameras simultaneously. The user-friendly camera name is displayed along with the camera video. The system is set up so that left clicking on the pane will “freeze-frame” the video in a particular pane. Right clicking on the pane will initiate various functions. Each video pane includes a drag and drop feature permitting the video in a pane to moved to any other pane, as desired.

In those monitoring stations having multiple displays, the primary display screen described above is also used to control the secondary screens. The secondary screens are generally used for viewing selected cameras and are configured by code executing on the primary screen. The video pane(s) occupy the entire active video area of the secondary screens.

The system supports a plurality of cameras and an encoder associated with each of the cameras, the high-resolution output signal and low-resolution output signal unique to each camera being transmitted to the router. A management system is associated with each display monitor whereby each of the plurality of display monitors is adapted for displaying any combination of camera signals independently of the other of said plurality of display monitors.

With specific reference to FIG. 5, the display screen 100 for the primary monitor screen is subdivided into three areas or zones, the map zone 102, the video display zone 104 and the control panel or zone 106. In the illustrated figure, the display zone is divided into a split screen 104a and 104b, permitting the video from two cameras to be simultaneously displayed. As previously stated, the display zone can be a full screen, single camera display, split screen or multiple (window pane) screens for displaying the video from a single or multiple cameras. The map zone 102 includes a map of the facility with the location and direction of cameras C1, C2, C3 and C4 displayed as icons on the map. The specific cameras displayed at the display screen are shown in the display window, here cameras C1 and C3. If different cameras are desired, the user simply places the mouse pointer on a camera in the map, clicks and drags the camera to a screen and it will replace the currently displayed camera, or the screen may be reconfigured to include empty panes.

The control panel 106 has various functions as previously described. As shown in FIG. 5, the control panel displays the camera angle feature. In this operation, the selected camera (C1, C2, C3 or C4) is selected and the camera direction (or angle) will be displayed. The user then simply changes the angle as desired to select the new camera direction. The new camera direction will be maintained until again reset by the user, or may return to a default setting when the user logs off, as desired.

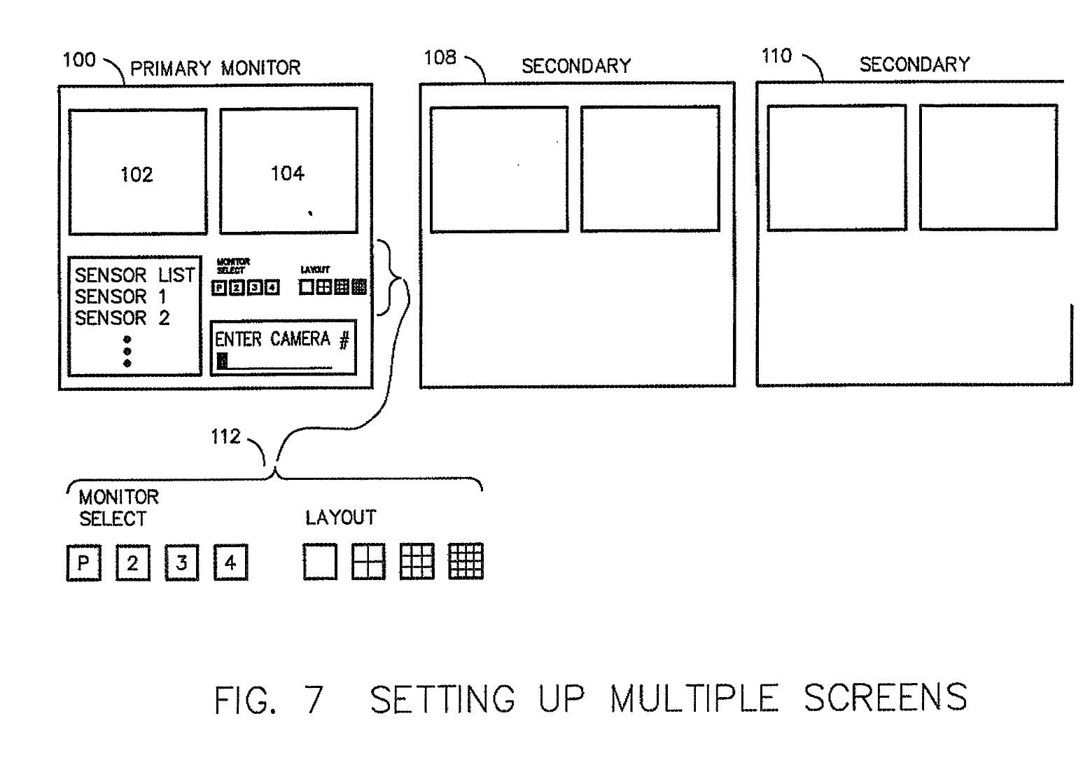

FIG. 7 illustrated the primary screen 100 with the map zone 102 and with the viewing zone 104 now reconfigured into a four pane display 104a, 104b, 104c, 104d. The control panel 106 is configured to list all of the cameras (here cameras C1, C2 and C3). The user may either point and click on a camera in the map and the camera will be highlighted on the list, or vise versa, the user may highlight a camera on the list and it will flash on the map. The desired camera may then be displayed in the viewing windows by the previously described drag-and-click method.

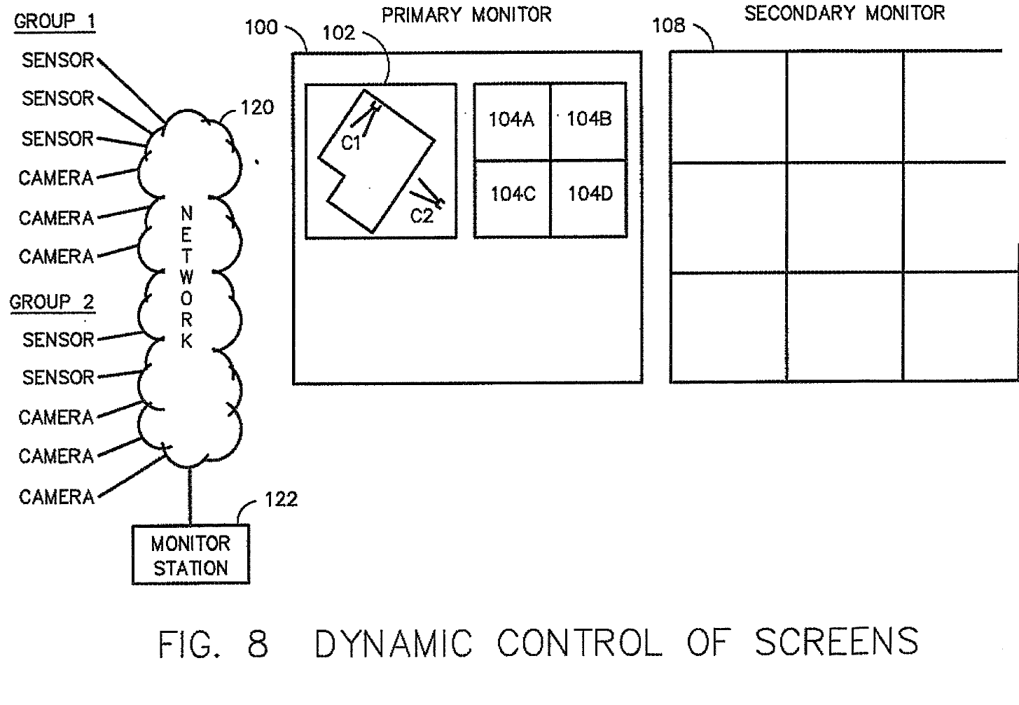

FIG. 7 shows a primary monitor 100 in combination with one or more secondary monitors 108 and 110. The primary monitor includes the map zone 102, the display zone 104 and the control panel 106 as previously described. As shown in a partial enlarged view, the control panel will include control “buttons” 112 for selecting the various primary “P” and numbered secondary monitors. Once a monitor is selected, the display configuration may then be selected ranging from full screen to multiple panes. Thus each monitor can be used to display different configurations of cameras. For example, in practice it is desirable that the primary monitor is used for browsing, while one secondary monitor is a full screen view of a selected camera and a second secondary monitor is divided into sufficient panes to display all cameras on the map. This is further demonstrated in FIG. 8.

The system of the present invention greatly enhances the surveillance capability of the user. The map not only permits the user to determine what camera he is looking at but also the specific direction of the camera. This can be done by inputting the angular direction of the camera, as indicated in FIG. 5, or by rotating the camera icon with the mouse, or by using an automatic panning head on the camera. When using the panning head, the head is first calibrated to the map by inputting a reference direction in degrees and by using the mouse on the map to indicate a defined radial using the camera as the center point.

The camera icon on the map can be used to confirm that a specific camera has been selected by hovering over a pane in the selected screen (whole, split or multiple), whereby the displayed video will be tied to a highlighted camera on the map. The mouse pointer can also be used to identify a camera by pointing to a camera on the sensor list, also causing the selected camera to be highlighted on the map zone. When automatic event detection is utilized, an event detection sensor will cause a camera to be activated, it will then be highlighted on the map and displayed on the video display zone. Event detection can include any of a number of event sensors ranging from panic buttons to fire detection to motion detection and the like. Where desired, different highlighting colors may be used to identify the specific event causing the camera activation.

The screen configuration may be by manual select or automatic. For example, a number of cameras may be selected and the screen configuration may be set to display the selected number of cameras in the most efficient configuration. This can be accomplished by clicking on the camera icons on the map, selecting the cameras from the sensor list, or typing in the selected cameras. In the most desired configuration, an event detection will automatically change the display configuration of the primary screen to immediately display the video from a camera experiencing an event phenomenon. Cameras may also be programmed to be displayed on a cyclical time sequenced or other pre-programmed conditions, including panning, by way of example.

Specifically, the screen configuration is dynamic and can be manually changed or changed automatically in response to the detection of events and conditions or through programming.

One aspect of the invention is the intuitive and user-friendly method for selecting cameras to view. The breadth of capability of this feature is shown in FIG. 3. The main user interface screen provides the user with a map of the facility, which is overlaid with camera-shaped icons depicting location and direction of the various cameras and encoders. This main user interface has, additionally, a section of the screen dedicated to displaying video from the selected cameras.

The video display area of the main user interface may be arranged to display a single video image, or may be subdivided by the user into arrays of 4, 9, or 16 smaller video display areas. Selection of cameras, and arrangement of the display area, is controlled by the user using a mouse and conventional Windows user-interface conventions. Users may:

Select the number of video images to be displayed within the video display area. This is done by pointing and clicking on icons representing screens with the desired number of images.

Display a desired camera within a desired ‘pane’ in the video display area. This is done by pointing to the desired area on the map, then ‘dragging’ the camera icon to the desired pane.

Edit various operating parameters of the encoders. This is done by pointing to the desired camera, the right-clicking the mouse. The user interface then drops a dynamically generated menu list that allows the user to adjust the desired encoder parameters.

While specific features and embodiments of the invention have been described in detail herein, it will be understood that the invention includes all of the enhancements and modifications within the scope and spirit of the following claims.

What is claimed is:

1. A system for capturing, encoding and transmitting continuous video from a camera to a display monitor via a network, comprising:
a. A display monitor for displaying video from the camera;
b. The display monitor being separated into a plurality of operating zones, including;
c. A map zone including a camera icon on the map for indicating where the camera is located;
d. A display zone for displaying the video captured by the camera; and
e. A control zone for on screen control of the camera, map and display functions.

2. The system of claim 1, further including a plurality of cameras, each identified by a specific icon on the map.

3. The system of claim 1, further including a directional character for indicating the direction where the camera is aimed within the map.

4. The system of claim 3, further including a selector adapted for altering the direction of the camera.

5. The system of claim 4, wherein the camera direction selector is controlled by typing in a camera angle.

6. The system of claim 4, wherein the camera direction selector is controlled by rotating the camera icon.

7. The system of claim 4, wherein the camera direction selector is automatically controlled by a panning feature on the camera and is always displayed on the map.

8. The system of claim 5, further including a control device adapted for assigning a priority to an event captured at a camera and activating a display of the camera video based on the event occurrence.

9. The system of claim 2, wherein the display zone may be configured to selectively display the video from any single camera or any combination of the cameras.

10. The system of claim 2, further including a plurality of monitors with a first monitor being designated as a primary monitor and including the map zone, display zone and the control zone and with an additional monitor being designated a secondary monitor with the entire video screen function being dedicated to the display of camera videos.

11. The system of claim 10, wherein the control function of the primary monitor is used to control the video display on the secondary monitor.

12. The system of claim 1, wherein the display monitor includes a mapping feature illustrating the location of the camera.

13. The system of claim 12, wherein the output signal for the camera may be selected by activating the camera location on the mapping feature.

14. The system of claim 10, wherein the prismary monitor includes a control for selectively subdividing the display area of the secondary monitor into a plurality of panes for simultaneously displaying a pluralityof video images from a selected plurality of cameras.

15. The system of claim 1, wherein the display monitor includes an initial logon screen presented to the user, and wherein access to the user is denied until a user.

16. The system of claim 15, wherein the logon screen includes a select feature adapted for permitting the user to elect the loading of presets.

17. The system of claim 15, wherein the logon screen includes a select feature adapted for permitting the user to customize the system.

18. The system of claim 1, wherein the display monitor is implemented as HTML or XML pages generated by a network application server.

19. The system of claim 1, wherein the map zone includes a plurality of maps.

20. The system of claim 19, wherein the plurality of maps are accessed via a pull or drop-down menu.

21. The system of claim 20, wherein each of the maps further includes graphical icons depicting sensors which are accessible by the system.

22. The system of claim 2, further including a graphical icon for depicting each camera and representing the location of the camera on the map.

23. The system of claim 22, wherein the graphical icon representing a camera is constructed for clearly depicting the direction in which the camera is currently pointed.

24. The system of claim 2, including a drop-down menu associated with each camera for selecting operating parameters of the camera including still-frame capture versus motion capture, bit-rate of the captured and compressed motion video, camera name, camera caption, camera icon direction in degrees, network address of the various camera encoders, and quality of the captured still-frame or motion video.

25. The system of claim 22, further including a control for selecting and dragging a camera to the display zone whereby a users may cause video to be displayed in any given pane by dragging the desired camera icon to a desired display pane and dropping it.

26. The system of claim 25, wherein a user may clear any desired display pane by dragging the selected video off of the display pane, and dropping it.

27. The system of claim 1, further including a drop-down menu in the display zone including operating information relating to the video displayed therein.

28. The system of claim 27, said information including camera network address, current network bandwidth used, images size expressed in pixels, type of codec used to capture and display the video, type of error correction currently employed, number of video frames skipped, captured frame rate, encoded frame rate, and number of network data packets received, recovered after error correction, or lost.
